(19) United States
(12) Patent Application Publication
(10) Pub. No.: US 2014/0019537 A1
(43) Pub. Date: Jan. 16, 2014

(54) Configurable Community Platform

(71) Applicants: Gaurav Rajkumar Doshi, Seattle, WA (US); Emre Bogazliyanlioglu, Kirkland, WA (US)

(72) Inventors: Gaurav Rajkumar Doshi, Seattle, WA (US); Emre Bogazliyanlioglu, Kirkland, WA (US)

(73) Assignee: MICROSOFT CORPORATION, Redmond, WA (US)

(21) Appl. No.: 13/548,876

(22) Filed: Jul. 13, 2012

(51) Int. Cl. G06F 15/16

(52) U.S. Cl. 709/204; 709/223

(57) ABSTRACT

Technologies are described herein for providing a configurable community platform. A community reputation settings page may be provided. The community reputation settings page may include first functionality and second functionality. The first functionality may be configured to receive a first administrator customization of a rating system for a community page. The second functionality may be configured to receive a second administrator customization of an achievement point system for the community page. The first administrator customization of the rating system and the second administrator customization of the achievement system may be received via the community reputation settings page. The community page may be configured in accordance with the first administrator customization and the second administrator customization.

### BACKGROUND

An enterprise may implement a content management platform as a way for the enterprise to manage content in a secure and convenient manner. For example, some content management platforms may provide functionality enabling members of the enterprise to create, store, share, retrieve, and/or update documents in accordance to various rules set by an administrator. As a result, such content management platforms can facilitate collaboration of content between members of the enterprise.

In addition to the management of content, some content management platforms may also provide for the establishment of communities in which members can join and participate. For example, each community may include functionality whereby members can share their collective knowledge about a particular category. Each community may be associated with a different category. Thus, members can join and participate in select communities associated with categories that interest them, find other members who also have also share an interest in these categories, share their own expertise on these categories, and/or find other members who have expertise on these categories.

A drawback with conventional content management platforms that provide communities is lack of customization. In particular, a typical administrator who establishes the communities for an enterprise may have little or no programming knowledge. As a result, conventional content management platforms may be designed to provide only a single configuration or a limited number of configurations of a community. In this way, communities can be easily set up without error by a non-programmer. However, some administrators may desire or demand a greater level of customization.

It is with respect to these considerations and others that the disclosure made herein is presented.

### SUMMARY

Technologies are described herein for providing a configurable community platform. The configurable community platform may be configured to provide a community reputation settings page for customizing a community. For example, the community may be utilized promote a collaborative environment within an enterprise network. The community reputation settings page may include functionality for customizing various aspects of the community, including the rating system of the community and/or the achievement point system of the community. By utilizing the configurable community platform, a community administrator can create multiple communities, each having its own customized user experience.

In some example technologies, a method for providing a configurable community platform is provided. The method may include providing a community reputation settings page comprising first functionality and second functionality. The first functionality may be configured to receive a first administrator customization of a rating system for a community page. The second functionality may be configured to receive a second administrator customization of an achievement point system for the community page. The method may also include receiving, via the community reputation settings page, the first administrator customization of the rating system and the second administrator customization of the achievement system. The method may further include configuring the community page in accordance with the first administrator customization and the second administrator customization.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating an example community platform architecture, in accordance with some embodiments;

FIG. 2 is a screen display diagram illustrating an example implementation of a community reputation settings page, in accordance with some embodiments;

FIG. 3A is a screen display diagram illustrating example profiles for which a community administrator has specified that an achievement badge is displayed as an image, in accordance with some embodiments;

FIG. 3B is a screen display diagram illustrating example profiles for which a community administrator has specified that an achievement badge is displayed as text, in accordance with some embodiments;

FIG. 4 is a flow diagram illustrating an example method for providing a configurable community platform, in accordance with some embodiments; and

FIG. 5 is a computer architecture diagram showing an illustrative computer hardware architecture for a computing system capable of implementing the embodiments presented herein.

### DETAILED DESCRIPTION

The following detailed description is generally directed to concepts and technologies for providing a configurable community platform. Through the use of the concepts and technologies described herein, a community administrator can create communities having different user experiences. In particular, the community administrator may configure reputation-related features of the communities.

The configurable community platform may provide access to a community reputation settings interface for each community. Through community reputation settings interface, the community administrator can configure reputation-related features of the community by making certain selections and/or defining certain values. Functionality provided by the community reputation settings interface for configuring reputation-related features of the community may be embodied in various interface elements, such as radio buttons, text boxes, check boxes, drop-down boxes, pop-up windows, or the like.

In a first example, the community reputation settings interface may provide functionality enabling the community administrator to enable or disable a rating system in the community. When the rating system is enabled, users can rate posts or replies made by users in the community. When the rating system is disabled, users cannot rate posts or replies made by users in the community.

In a second example, the community reputation settings interface may provide functionality enabling the community administrator to configure the rating system, if the rating system has been enabled. Example functionality may enable the community administrator to select whether the rating system uses a simple, binary rating system (e.g., a “like” button) or a more detailed multi-level rating system (e.g., five-star rating system).

In a third example, the community reputation settings interface may provide functionality enabling the community administrator to enable or disable an achievement point system in the community. When an achievement point system is enabled, each user can acquire points for various activities related to the user's participation in the community. Some examples of activities related to the user's participation in the community may include creating a new post, replying to a post, receiving a positive rating for a post or reply, or having a reply being designated as a “best reply” in a discussion.

In a fourth example, the community reputation settings interface may provide functionality enabling the community administrator to configure point values for the achievement point system, if the achievement point system has been enabled. Example functionality may enable the community administrator to define the amount of points acquired by the user for each activity. Thus, the community administrator can associate fewer points for certain activities and higher points for other activities.

In a fifth example, the community reputation settings interface may provide functionality enabling the community administrator to configure achievement levels for the achievement point system, if the achievement point system has been enabled. Example functionality may enable the community administrator to specify a minimum number of points that a user would need to acquire in order to reach various achievement levels. Such achievement levels may be provided within the community as a way to incentivize participation by the users.

In some embodiments, the community reputation settings interface may be configured to enforce one or more verification rules that the community administrator is instructed follow when configuring the achievement levels. One example verification rule may prevent the community administrator from entering point ranges that have gaps or overlaps between achievement levels. Another example verification rule may prevent the community administrator from entering a negative point threshold for an achievement level. Other verification rules may be contemplated by one skilled in the art.

In a sixth example, the community reputation settings interface may provide functionality enabling the community administrator to configure achievement badges for the achievement point system, if the achievement point system has been enabled. Each achievement level may be associated with a different achievement badge. As a user advances to a new achievement level, the user may acquire the corresponding achievement badge. The achievement badge may be displayed in the user's profile as a way for other users to identify the level and/or quality of participation of the user.

Example functionality may enable the community administrator to specify whether the achievement badge is displayed as an image (e.g., a series of one or more highlighted symbols) or as text (e.g., newbie, expert, VIP, MVP). If the community administrator specifies that the achievement badge is displayed as an image, example functionality may further enable the community administrator to select an image from multiple available images or to upload an image. If the community administrator specifies the achievement badge is displayed as text, example functionality may further enable the community administrator to define the text shown for the achievement badge of each achievement level.

In a seventh example, the community reputation settings interface may provide functionality enabling the community administrator to configure gifted badges for the achievement point system, if the achievement point system has been enabled. A gifted badge may refer to a custom badge that is assigned to a user in place of the user's achievement badge. The gifted badge may be utilized to acknowledge a special user of the community (e.g., a celebrity), to acknowledge a special achievement of a user, and/or to easily identify a certain user (e.g., a moderator). It should be appreciated that such gifted badges may or may not be associated with special privileges in the community apart from other users.

It should be appreciated that a given community reputation settings may include one or more of the above described interface elements. It should also be appreciated that the above described examples of interface elements are merely illustrative and are not intended to be limiting. Other configurations of various reputation-related features of the community may be facilitated via additional interface elements as contemplated by one skilled in the art.

After the community administrator has configured the reputation-related features of the community via the community reputation settings page, the community administrator may launch the community in the enterprise network. Users may join and participate in the community. The community may include, at least in part, a discussion board enabling users to discuss various topics related to the category associated with the community. Participation on the discussion board may include creating a new post on a particular topic, replying to the post, or rating the post or reply. Additionally, each post or reply may be displayed alongside a profile of the user who creating the post or reply. For example, the profile may include the user's name, the user's photograph or an avatar associated with the user, and an achievement badge or gifted badge.

As used herein, an “original poster” may refer to a user who creates a new post. Also as used herein, a “discussion” may refer collectively to a given post and any replies to that post. The discussion board may include multiple discussions, and the discussions may be arranged in a particular order. Also as used herein, a “user” may refer to only those users (e.g., employees) that have access to the enterprise network. Also as used herein, a “page” may refer to a web page. Also as used herein, a “link” may refer to a hyperlink.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

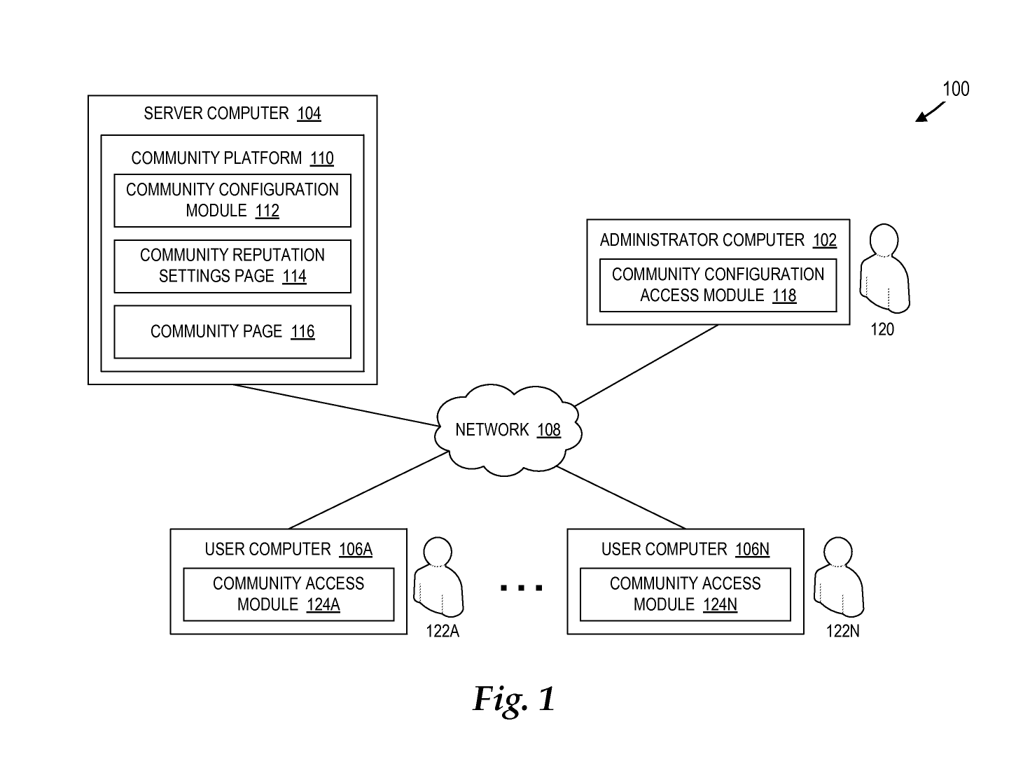

In the following detailed description, references are made to the accompanying drawings that form a part hereof, and which are shown by way of illustration, specific embodiments, or examples. Referring now to the drawings, in which like numerals represent like elements through the several figures, a computing system and methodology for providing a configurable community platform is provided. In particular, FIG. 1 is a block diagram illustrating an example community platform architecture 100, in accordance with some embodiments. The community platform architecture 100 may include an administrator computer 102, a server computer 104, and user computers 106A-106N. The user computers 106A-106N may be collectively or generically referred to as user computers 106. The administrator computer 102, the server computer 104, and the user computers 106 may be communicatively coupled via a network 108. For example, the network 108 may be an enterprise network, such as a local area network (“LAN”), a wide area network (“WAN”), or the like.

The server computer 104 may include community platform 110. Although not illustrated in FIG. 1, the community platform 110 may be part of a content management system in accordance with some embodiments. The community platform 110 may include a community configuration module 112 that is utilized to configure one or more communities. Each community may be associated with a community reputation settings page, such as a community reputation settings page 114, and a community page, such as a community page 116.

The administrator computer 102 may include a community configuration access module 118. A community administrator 120 may utilize the community configuration access module 118 to access the community reputation settings page 114. In some embodiments, the community configuration access module 118 may be a web browser configured to access the community reputation settings page 114. As described in greater detail below, the community administrator 120 may utilize the community reputation settings page 114 to configure reputation-related features of the community page 116.

Reputation-related features may refer generally to aspects of the community that affect the reputation of the community itself, the reputation of a discussion, the reputation of a post or reply, and/or the reputation of one or more users. Some example reputation-related features that can be configurable by the community administrator 120, via the community reputation settings page 114, may include a rating system and an achievement point system.

Example configurations of a community may enable or disable a rating system of the community. If the rating system is enabled, example configurations of the community may specify how users can rate posts and replies. Example configurations of the community may enable or disable an achievement point system of the community. If achievement point system is enabled, example configurations of the community may specify (a) the number (i.e., quantity) of points a user acquires for various activities related to the user's participation in the community, (b) the number of points a user would need to acquire in order to reach various achievement levels, (c) achievement badges associated with the achievement levels, and/or (d) gifted badges associated with certain users.

The community reputation settings page 114 may be accessed by the community administrator 120 when the community administrator sets up the community page 116. The community reputation settings page 114 may also be accessed by the community administrator 120 after the community page 116 has been launched in order to make changes to the configuration of the community page 116. Users 122A-122N may access the community page 116 via community access modules 124A-124N. The users 122A-122N may be collectively or generically referred to as users 122. The community access modules 124A-124N may be collectively or generically referred to as community access modules 124. In some embodiments, the community access modules 124 may be web browsers configured to access the community page 116.

According to various embodiments, the community page 116 may include a discussion board (not shown). By default, the discussion board may include functionality enabling users to create a new post (which may also start a new discussion) and to reply to existing posts. The discussion board may also include functionality enabling the original poster (i.e., the user who created the post) to designate the “best reply” from the replies in the discussion. For example, the original poster may select the reply that is the most helpful, the most complete, the most accurate, and/or some other measure of quality.

Depending on the configuration of community, the users 122 may be able to rate posts and replies in discussions, acquire points, and/or reach various achievement levels based on the acquired points. Also depending on the configuration of the community, the users 122 may be associated with badges that are displayed on profiles of the users 122. Such badges may include achievement badges that are associated with the achievement levels of the users 122. In the alternative, such badges may include gifted badges that are assigned by the community administrator 120 to identify special users.

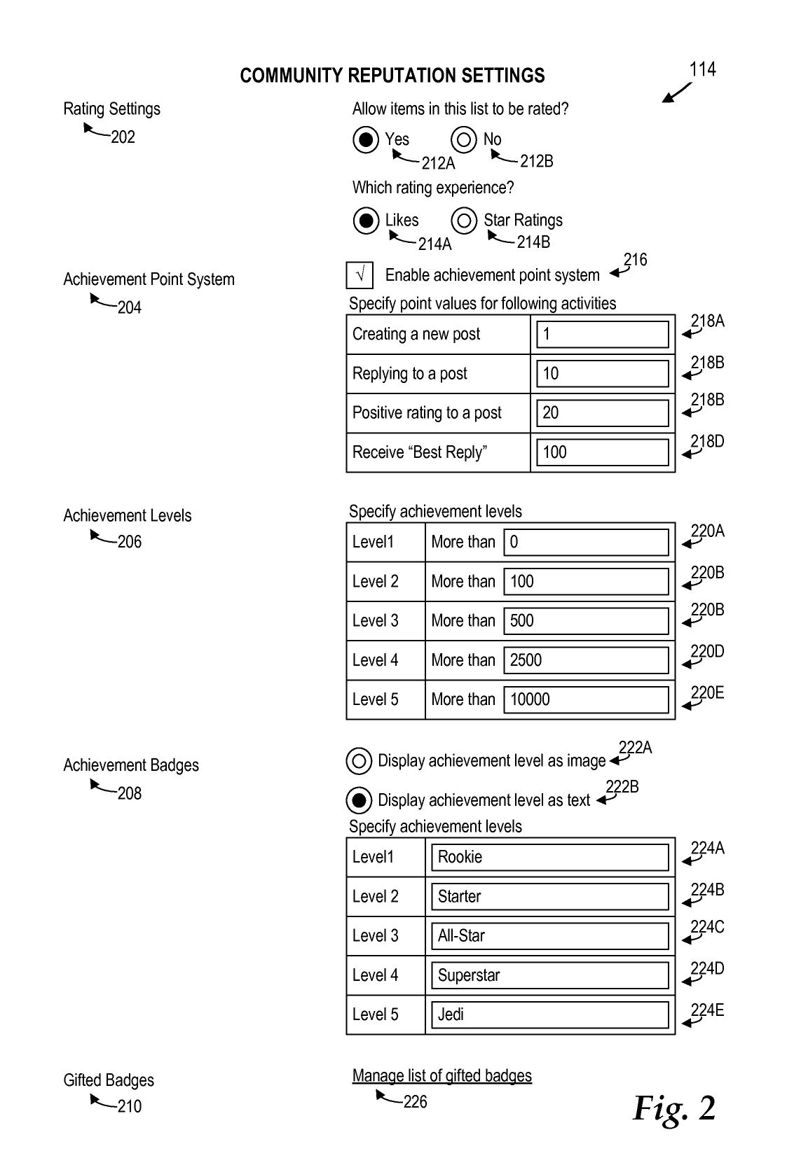

Referring now to FIG. 2, additional details regarding the community reputation settings page 114 will be provided. In particular, FIG. 2 is a screen display diagram illustrating an example implementation of the community reputation settings page 114, in accordance with some embodiments. For example, the community administrator 120 may access the community reputation settings page 114 via the community configuration access module 118. The community administrator 120 may configure various reputation-related features of a community using the community reputation settings page 114.

The community reputation settings page 114 includes a rating settings section 202, an achievement point system section 204, an achievement level section 206, an achievement badges section 208, and a gifted badges section 210. The rating settings section 202 may include at least one first interface element (e.g., illustrated in FIG. 2 as radio buttons 212A-212B) whereby the community administrator 120 can select whether posts and replies can be rated. In particular, the community administrator 120 can select the “Yes” radio button 212A to specify that posts and replies can be rated or select the “No” radio button 212B to specify that posts and replies cannot be rated.

The rating settings section 202 may further include at least one second interface element (e.g., illustrated in FIG. 2 as radio buttons 214A-214B) whereby the community administrator 120 can select a rating experience. The rating experience may specify whether posts and replies can be rated according to a binary rating system or a multi-level rating system. The community administrator 120 may select the “Likes” radio button 214A to specify a binary rating system or select the “Star Ratings” radio button 214B to specify a multi-level rating system. Under a binary rating system, a user may be provided with, for example, a “like” button for each post of reply. If a user positively rates a given post or reply, the user can select the “like” button. If a user negatively rates a given post or reply, the user can choose not to select the “like” button. Whether the user chooses to select or not select the “like” button, the user cannot specify a rating level of the post or reply.

Under the multi-level rating system, a user may be provided with, for example, a five-star rating interface. Through the five-star rating interface, the community administrator 120 can specify a rating level for a given post or reply. If a user believes that a post or reply is poor quality, then the user can rate the post or reply as zero stars or one star. If a user believes that a post or reply is high quality, then the user can rate the post or reply as four stars or five stars. By enabling the users 122 to specify rating levels of posts or replies, the multi-level rating system can provide a more detailed rating over the binary rating system. Multiple users can rate a particular post or reply.

The achievement point system section 204 may include at least one third interface element (e.g., illustrated in FIG. 2 as a check box 216) whereby the community administrator 120 can enable or disable an achievement point system for the community. Through the achievement point system, each of the users 122 can acquire points for performing various activities related to participating in the community. In particular, the community administrator 120 can mark the check box 216 to enable the achievement point system or unmark the check box 216 to disable the achievement point system.

The achievement point system section 204 may further include at least one fourth interface element (e.g., illustrated in FIG. 2 as a series of text boxes 218A-218D) whereby the community administrator 120 can enter a number of points acquired by a user for various activities related to participating in the community. In the first text box 218A, the community administrator 120 can specify the number of points a user acquires for creating a new post. In the second text box 218B, the community administrator 120 can specify the number of points a user acquires for replying to a post. In the third text box 218C, the community administrator 120 can specify the number of points a user acquires when another user, such as a second user, provides a positive rating for the user's post or reply. For example, the second user may provide a positive rating for the user's post or reply by selecting the “like” button for the post or reply under a binary rating system or by rating the post or reply four or five stars under a multi-level rating system. In the fourth text box 218D, the community administrator 120 can specify the number of points a user acquires when the original poster designates the user's reply as “best reply” in a discussion.

The achievement level section 206 may include at least one fifth interface element (e.g., illustrated as a series of text boxes 220A-220E) whereby the community administrator 120 can enter a number of points a user needs in order to reach various achievement levels. In the first text box 220A, the community administrator 120 can specify the number of points a user needs to acquire to reach a first level (e.g., Level 1). In the second text box 220B, the community administrator 120 can specify the number of points a user needs to acquire to reach a second level (e.g., Level 2). In the third text box 220C, the community administrator 120 can specify the number of points a user needs to acquire to reach a third level (e.g., Level 3). In the fourth text box 220D, the community administrator 120 can specify the number of points a user needs to acquire to reach a fourth level (e.g., Level 4). In the fifth text box 220E, the community administrator 120 can specify the number of points a user needs to acquire to reach a fifth level (e.g., Level 5).

The achievement badges section 208 may include at least one sixth interface element (e.g., illustrated in FIG. 2 as a radio buttons 222A-222E and text boxes 224A-224E) whereby the community administrator 120 can configure a representation of achievement badges for users. A different achievement badge may be associated with each achievement level. Thus, when a user reaches a new achievement level, the user may also receive a new achievement badge. A user's achievement badge may be shown on the user's profile within the community.

In the sixth interface element, the community administrator 120 may select whether the achievement levels defined in the fifth interface element are displayed on a user's profile as an image or as text. As used herein, an “achievement badge” may refer to an image or text associated with an achievement level. The community administrator 120 may select the first radio button 222A to specify that the achievement level of a user is displayed on the user's profile as an image. For example, an image may include a series of five symbols (e.g., blocks, stars). One or more of the symbols can be highlighted to show a user's achievement level. That is, one highlighted symbol may indicate that a user has reached the first level (e.g., Level 1), while four highlighted symbols may indicate that the user has reached the fourth level (e.g., Level 4). Although not illustrated in FIG. 2, other embodiments may provide additional functionality whereby the community administrator 120 can select an image from multiple predefined images and/or upload a new image.

The community administrator 120 may select the second radio button 222B to specify that the achievement level of a user is displayed on the user's profile as text. In particular, when the community administrator 120 selects the second radio button 222B, the community administrator 120 can also specify the text that is displayed for each achievement level in the text boxes 224A-224E. In the first text box 224A, the community administrator 120 can specify the text that is displayed in a user's profile to indicate that user has reached the first level (e.g., Level 1). In the second text box 224B, the community administrator 120 can specify the text that is displayed in a user's profile to indicate that user has reached the second level (e.g., Level 2). In the third text box 224C, the community administrator 120 can specify the text that is displayed in a user's profile to indicate that user has reached the third level (e.g., Level 3). In the fourth text box 224D, the community administrator 120 can specify the text that is displayed in a user's profile to indicate that user has reached the fourth level (e.g., Level 4). In the fifth text box 224E, the community administrator 120 can specify the text that is displayed in a user's profile to indicate that user has reached the fifth level (e.g., Level 5).

The gifted badges section 210 may include at least one seventh interface element (e.g., illustrated in FIG. 2 as a link 226) whereby the community administrator 120 can assign gifted badges for certain users (i.e., a subset of the users). When a user is assigned a gifted badge, the gifted badge may replace the user's achievement badge in the profile. According to some embodiments, when the community administrator 120 selects the link 226, the seventh interface element may display pop-up window (not shown). Through the pop-up window, the community administrator 120 can input a user and assign one of multiple gifted badges to the user. The gifted badges allow other members to easily identify when special users when they participate in the community. In one example, a celebrity user may be assigned a celebrity badge to the celebrity user. In another example, a moderator of the community may be assigned a moderator badge.

It should be appreciated that one or more portions of the community reputation settings page 114 may be grayed out or otherwise inaccessible depending on previous inputs by the community administrator 120. In one example, if the “No” radio button 212B is selected, then the rest of the community reputation settings page 114 may be grayed out because a rating system is not enabled. In another example, if the first radio button 222A is selected, then the text boxes 224A-224E may be grayed out.

According to some embodiments, the point values specified in the text boxes 218A-218D and/or the achievement levels specified in the text boxes 220A-220E may be extensible and/or configurable. In one example, the community administrator 120 may be able to specify different and/or additional activities (e.g., posting a photograph, filling out a profile) for which the users 122 can acquire points. In another example, the community administrator 120 may be able to specify a different number of achievement levels and/or different titles of achievement levels.

According to some embodiments, when the users 122 view the community page 116, the community page 116 may be configured to arrange the discussions in the discussion board in a particular order. In particular, the discussions may be arranged (e.g., sorted) according to a reputation score of each discussion. For example, discussions having a higher reputation score may be displayed at or near the top of the discussion board, and discussions having a lower reputation score may be displayed at or near the bottom of the discussion board or not displayed at all. In some implementations, the reputation score for a given discussion may be determined according to a predefined formula that takes into account, for example, the age of the post in the discussion, the age of the last reply in the discussion, the number of replies in the discussion, the number of high quality replies (e.g., according to their ratings) in the discussion, or the like. In some other implementations, the predefined formula may be configurable by the community administrator 120.

According to some embodiments, the reputation level of each of the users 122 according to their current achievement level can be made available via a search program. For example, illustrative communities may include a photography community and a patent law community. The search program may enable users to enter a query for “photography experts.” In response to this query, the search program may be configured to find, at least in a part, users of the photograph community who have reached a high achievement level. Similarly, the search program may enable users to enter a query for “patent law experts.” In response to this query, the search program may be configured to find, at least in part, users of the patent law community who have reached a high achievement level.

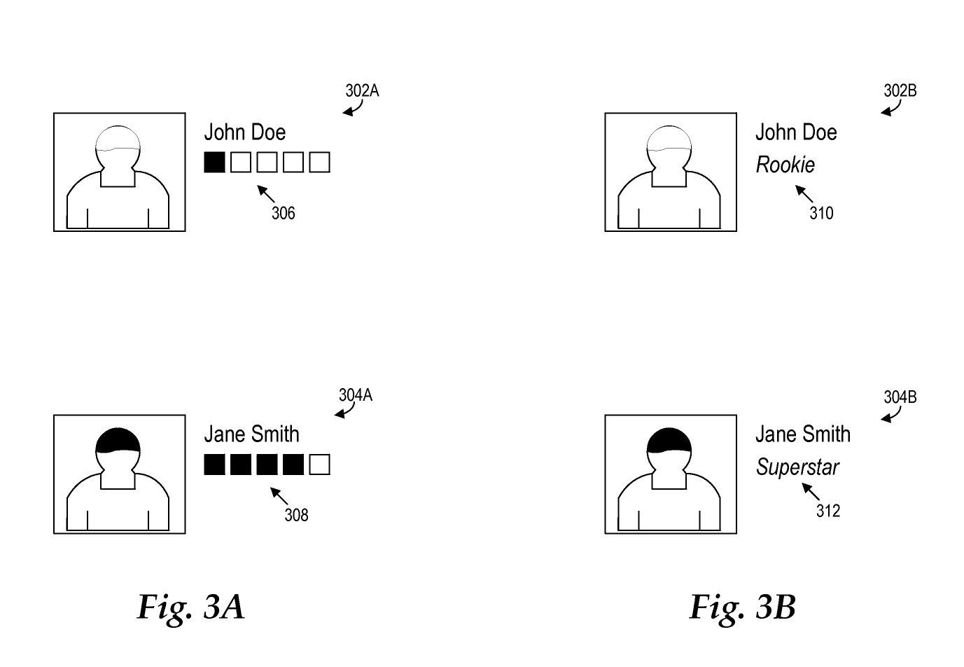

Referring now to FIGS. 3A and 3B, additional details regarding achievement badges will be provided. In particular, FIG. 3A is a screen display diagram illustrating example profiles 302A, 304A for which the community administrator 120 has specified that an achievement badge is displayed as an image, in accordance with some embodiments. The profiles 302A, 304A may be displayed in a variety of ways within the community. In one implementation, each profile may be displayed on individual profile pages. In another implementation, multiple profiles may be displayed on a members list that includes participants of the community. In yet another implementation, a user's profile may be displayed next to each post or reply made by the user. In this manner, other users can easily identify the user who made the post or reply, as well as the user's reputation in the community.

As illustrated in FIG. 3A, the first profile 302A is directed to a first user named “John Doe.” The first user has achieved the first level (e.g., Level 1) as indicated by an image 306. In particular, the image 306 contains a series of five blocks, and only one of the five blocks is highlighted. The second profile 304A is directed to a second user named “Jane Smith.” The second user has achieved the fourth level (e.g., Level 4) as indicated by an image 308. In particular, the image 308 contains a series of five blocks, and four of the five blocks are highlighted.

FIG. 3B is a screen display diagram illustrating example profiles 302B, 304B for which the community administrator 120 has specified that an achievement badge is displayed as text, in accordance with some embodiments. The first profile 302B, which corresponds to the first profile 302A, is also directed to the first user named “John Doe.” The first user has achieved the first level (e.g., Level 1) as indicated by an image 310. In particular, the image 310 displays the text “Rookie” which corresponds to the first level as indicated in the first text box 224A illustrated in FIG. 2. The second profile 304B, which corresponds to the second profile 304A, is also directed to the second user named “Jane Smith.” The second user has achieved the fourth level (e.g., Level 4) as indicated by the image 312. In particular, the image 312 contains the text “Superstar” which corresponds to the fourth level as indicated in the fourth text box 224D illustrated in FIG. 1. It should be appreciated that the profiles 302A, 304A and the profiles 302B, 304B may each contain additional information, such as the number of posts made, the number of replies made, or the number of replies that have been designated as “best reply” in various discussions.

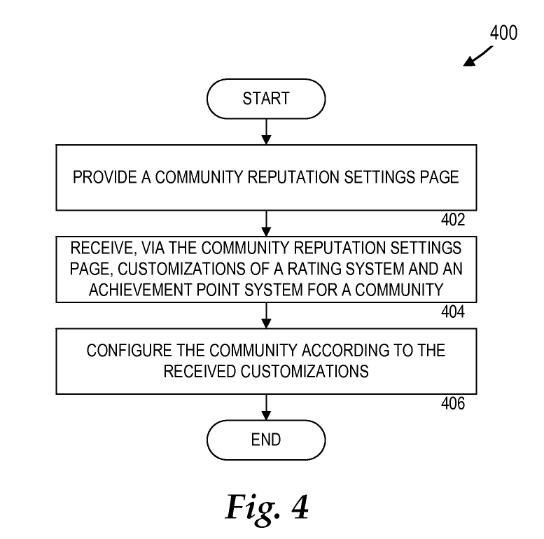

Referring now to FIG. 4, additional details regarding the operation of the community configuration module 112 will be provided. In particular, FIG. 4 is a flow diagram illustrating an example method for providing a configurable community platform, in accordance with some embodiments. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 4, a routine 400 begins at operation 402, wherein the community configuration module 112 provides a community reputation settings page, such as the community reputation settings page 114, to a community administrator, such as the community administrator 120. The community reputation settings page may include various interface elements that enable the community administrator to customize various aspects of a community, including the community's rating system and/or the community's achievement point system. After operation 402, the routine 400 proceeds to operation 404.

At operation 404, the community configuration module 112 receives the customizations from the community administrator via the community reputation settings page. In particular, the community administrator may input various customizations for the community's rating system and/or the community's achievement point system. Such customizations can be made via the interface elements contained in the community reputation settings page. When the community administrator has finished inputting the customizations, the community administrator may submit the community reputation settings page to the community configuration module 112. After operation 404, the routine 400 proceeds to operation 406.

At operation 406, the community configuration module 112 configures the community according to the received customizations. The customizations may provide a different user experience in the community apart from other communities. After operation 406, the routine 400 may either repeat (e.g., periodically, continuously, or on demand as needed) or terminate. For example, community administrator may repeat the routine 400 in order to customize additional communities.

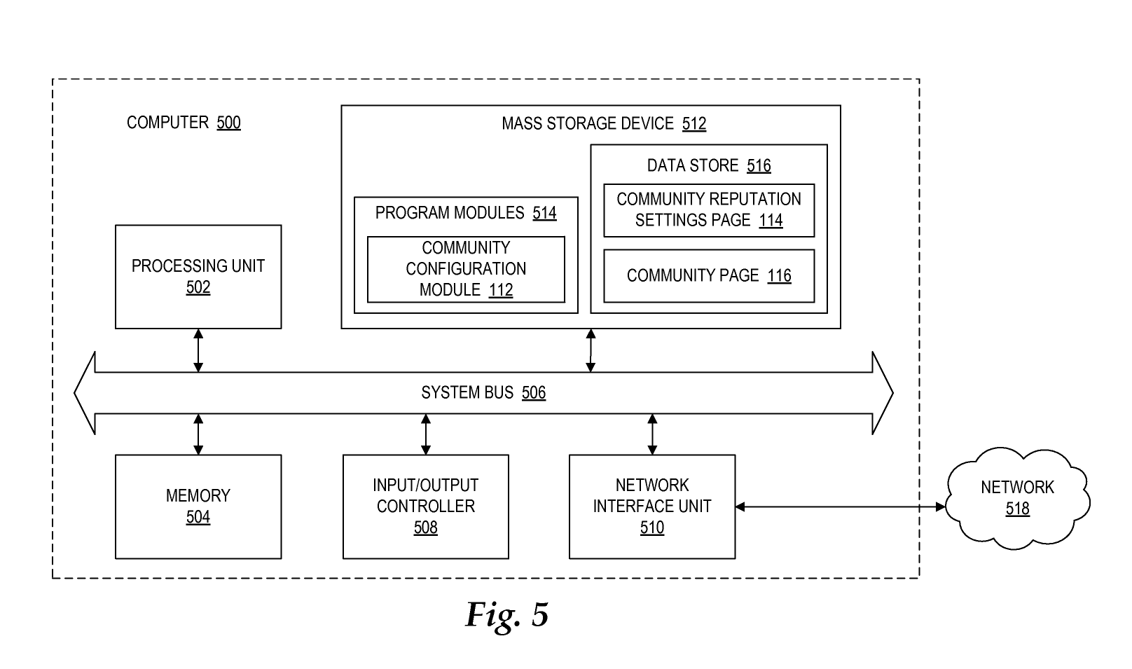

FIG. 5 is an example computer architecture diagram illustrating a computer 500. Examples of the computer 500 may include the administrator computer 102, the server computer 104, and the user computers 106. The computer 500 may include a central processing unit 502, a system memory 504, and a system bus 506 that couples the memory 504 to the central processing unit 502. The computer 500 may further include a mass storage device 512 for storing one or more program modules 514 and a data store 516. Examples of the program modules 514 may include the community configuration module 112, the community configuration access module 118, and the community access modules 124. The data store 516 may store multiple community reputation settings page/community page pairs, such as the community reputation settings page 114 and the community page 116, each pair corresponding to a different community. The community configuration module 112 may be configured to perform a method for providing a configurable community platform. In particular, the community configuration module 112 may be configured to provide the community reputation settings page 114 and to configure the community page 116 based on customizations received via the community reputation settings page 114. The mass storage device 512 may be connected to the processing unit 502 through a mass storage controller (not shown) connected to the bus 506. The mass storage device 512 and its associated computer-storage media may provide non-volatile storage for the computer 500. Although the description of computer-storage media contained herein refers to a mass storage device, such as a hard disk or CD-ROM drive, it should be appreciated by those skilled in the art that computer-storage media can be any available computer storage media that can be accessed by the computer 500.

By way of example, and not limitation, computer-storage media may include volatile and non-volatile, removable and non-removable media implemented in any method or technology for the non-transitory storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network 518. An example of the network 518 may be the network 108. The computer 500 may connect to the network 518 through a network interface unit 510 connected to the bus 506. It should be appreciated that the network interface unit 510 may also be utilized to connect to other types of networks and remote computer systems. The computer 500 may also include an input/output controller 508 for receiving and processing input from a number of input devices (not shown), including a keyboard, a mouse, a microphone, and a game controller. The input/output controller 508 may also be configured to receive user input via gestures, touch (e.g., via a touchscreen), and/or voice. Similarly, the input/output controller 508 may provide output to a display or other type of output device (not shown).

The bus 506 may enable the processing unit 502 to read code and/or data to/from the mass storage device 512 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 514 may include software instructions that, when loaded into the processing unit 502 and executed, cause the computer 500 to generate field sets. The program modules 514 may also provide various tools or techniques by which the computer 500 may participate within the overall systems or operating environments using the components, flows, and data structures discussed throughout this description. For example, the program modules 514 may implement interfaces for generating field sets.

In general, the program modules 514 may, when loaded into the processing unit 502 and executed, transform the processing unit 502 and the overall computer 500 from a general-purpose computing system into a special-purpose computing system customized to generate field sets. The processing unit 502 may be constructed from any number of transistors or other discrete circuit elements, which may individually or collectively assume any number of states. More specifically, the processing unit 502 may operate as a finite-state machine, in response to executable instructions contained within the program modules 514. These computer-executable instructions may transform the processing unit 502 by specifying how the processing unit 502 transitions between states, thereby transforming the transistors or other discrete hardware elements constituting the processing unit 502.

Encoding the program modules 514 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 514 may transform the physical state of the semiconductor memory, when the software is encoded therein. For example, the program modules 514 may transform the state of transistors, capacitors, or other discrete circuit elements constituting the semiconductor memory.

As another example, the computer-storage media may be implemented using magnetic or optical technology. In such implementations, the program modules 514 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that concepts and technologies for providing a configurable community platform are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing a configurable community platform, the method comprising:
providing, by a computer, a community reputation settings page comprising first functionality configured to receive a first administrator customization of a rating system and second functionality configured to receive a second administrator customization of an achievement point system for a community page;
receiving, via the community reputation settings page, the first administrator customization of the rating system and the second administrator customization of the achievement system; and
configuring the community page in accordance with the first administrator customization and the second administrator customization.

2. The method of claim 1, wherein the first functionality comprises a first interface element configured to receive a first administrator input specifying whether the rating system is enabled or disabled for the community page, wherein the rating system enables users of the community page to rate content provided by other users.

3. The method of claim 2, wherein the first functionality further comprises a second interface element configured to receive a second administrator input specifying, if the rating system is enabled, whether the rating system is implemented as a binary rating system or a multi-level rating system.

4. The method of claim 1, wherein the second functionality comprises a first interface element configured to receive a first administrator input specifying whether the achievement point system is enabled or disabled, wherein the achievement point system enables users to acquire achievement points for activities related to the users' participation in the community page.

5. The method of claim 4, wherein the second functionality further comprises a second interface element configured to receive a second administrator input specifying, if the achievement point system is enabled, a quantity of achievement points that each of the users acquires for each of the activities related to the users' participation in the community page.

6. The method of claim 5, wherein the second administrator input specifying the quantity of achievement points that each of the users acquires for each of the activities related to the users' participation in the community page comprises a first quantity of achievement points that each of the users acquires for creating a new post, a second quantity of achievement points that each of the users acquires for replying to an existing post, a third quantity of achievement points that each of the users acquires for receiving a positive rating to a previous reply or previous post, and a fourth quantity of achievement points that each of the users acquires for having the previous reply designated as a highest quality reply in a discussion.

7. The method of claim 6, wherein the second functionality further comprises a third interface element configured to receive a third administrator input specifying, if the achievement point system is enabled, a quantity of achievement points that each of the users needs to acquire to reach each of multiple achievement levels.

8. The method of claim 7, wherein the second functionality further comprises a fourth interface element configured to receive a fourth administrator input specifying, if the achievement point system is enabled, whether an achievement badge corresponding to each of the achievement levels is displayed in the community page as an image or a text.

9. The method of claim 8, wherein the second functionality further comprises a fifth interface element configured to receive a fifth administrator input comprising, if the achievement badge is specified to be displayed as the image, a selection of the image from a plurality of predefined images or an uploaded image.

10. The method of claim 8, wherein the second functionality further comprises a fifth interface element configured to receive a fifth administrator input specifying, if the achievement badge is specified to be displayed as text, a text-based badge for each of the achievement levels.

11. The method of claim 8, wherein the second functionality further comprises a fifth interface element configured to receive a fifth administrator input specifying a subset of the users that are assigned a gifted badge and specifying one or more types of the gifted badge assigned to the subset of the users.

12. The method of claim 8, wherein the second functionality further comprises a fifth interface element configured to receive a fifth administrator input specifying, if the achievement point system is enabled, a formula for computing a reputation score of each discussion in the community.

13. A computer-readable storage medium having computer-executable instructions stored thereon which, when executed by a computer, cause the computer to:
provide a community reputation settings page comprising first functionality configured to receive a first administrator customization of a rating system and second functionality configured to receive a second administrator customization of an achievement point system for a community page in an enterprise collaboration platform, the enterprise collaboration platform comprising a plurality of community pages including the community page;
receive, via the community reputation settings page, the first administrator customization of the rating system and the second administrator customization of the achievement system; and
configure the community page in accordance with the first administrator customization and the second administrator customization.

14. The computer-readable storage medium of claim 13, wherein the first functionality comprises a first interface element configured to receive a first administrator input specifying whether the rating system is enabled or disabled for the community page, wherein the rating system enables users of the community page to rate content provided by other users; and
wherein the first functionality further comprises a second interface element configured to receive a second administrator input specifying, if the rating system is enabled, whether the rating system is implemented as a binary rating system or a multi-level rating system.

15. The computer-readable storage medium of claim 14, wherein the second functionality comprises a third interface element configured to receive a third administrator input specifying whether the achievement point system is enabled or disabled, wherein the achievement point system enables users to acquire achievement points for activities related to the users' participation in the community page.

16. The computer-readable storage medium of claim 15, wherein the second functionality further comprises a fourth interface element configured to receive a fourth administrator input specifying, if the achievement point system is enabled, a quantity of achievement points that each of the users acquires for each of the activities related to the users' participation in the community page.

17. The computer-readable storage medium of claim 16, wherein the second functionality further comprises a fifth interface element configured to receive a fifth administrator input specifying, if the achievement point system is enabled, a quantity of achievement points that each of the users needs to acquire to reach each of multiple achievement levels.

18. The computer-readable storage medium of claim 17, wherein the second functionality further comprises a sixth interface element configured to receive a sixth administrator input specifying, if the achievement point system is enabled, whether an achievement badge corresponding to each of the achievement levels is displayed in the community page as an image or a text

19. A computer system, comprising:
a processor;
a memory communicatively coupled to the processor; and
a program module which executes in the processor from the memory and which, when executed by the processor, causes the processor to
provide a community reputation settings page comprising first functionality configured to receive a first administrator customization of a rating system and second functionality configured to receive a second administrator customization of an achievement point system for a community page,
receive, via the community reputation settings page, the first administrator customization of the rating system and the second administrator customization of the achievement system, and
configure the community page in accordance with the first administrator customization and the second administrator customization,
wherein the first functionality comprises a first interface element configured to receive a first administrator input specifying whether the rating system is enabled or disabled for the community page, wherein the rating system enables users of the community page to rate content provided by other users,
wherein the first functionality further comprises a second interface element configured to receive a second administrator input specifying, if the rating system is enabled, whether the rating system is implemented as a binary rating system or a multi-level rating system,
wherein the second functionality comprises a third interface element configured to receive a third administrator input specifying whether the achievement point system is enabled or disabled, wherein the achievement point system enables users to acquire achievement points for activities related to the users' participation in the community page,
wherein the second functionality further comprises a fourth interface element configured to receive a fourth administrator input specifying, if the achievement point system is enabled, a quantity of achievement points that each of the users acquires for each of the activities related to the users' participation in the community page,
wherein the second functionality further comprises a fifth interface element configured to receive a fifth administrator input specifying, if the achievement point system is enabled, a quantity of achievement points that each of the users needs to acquire to reach each of multiple achievement levels, and
wherein the second functionality further comprises a sixth interface element configured to receive a sixth administrator input specifying, if the achievement point system is enabled, whether an achievement badge corresponding to each of the achievement levels is displayed in the community page as an image or a text.

20. The computer system of claim 19, wherein the second functionality further comprises a seventh interface element configured to receive a seventh administrator input comprising, if the achievement badge is specified to be displayed as the image, a selection of the image from a plurality of predefined images or an uploaded image,
wherein the second functionality further comprises an eighth interface element configured to receive an eighth administrator input specifying, if the achievement badge is specified to be displayed as text, a text-based badge for each of the achievement levels, and
wherein the second functionality further comprises a ninth interface element configured to receive a ninth administrator input specifying a subset of the users that are assigned a gifted badge and specifying one or more types of the gifted badge assigned to the subset of the users.
